(19) United States
(12) Patent Application Publication
(10) Pub. No.: US 2022/0376482 A1
(43) Pub. Date: Nov. 24, 2022

(54) Bench Top Universal Wire Recycling System and Method

(71) Applicant: Thomas M Hans, Lombard, IL (US)

(72) Inventor: Thomas M Hans, Lombard, IL (US)

(21) Appl. No.: 17/816,722

(22) Filed: Aug. 1, 2022

Related U.S. Application Data
(63) Continuation of application No. 15/939,933, filed on Mar. 29, 2018, now abandoned.

(51) Int. Cl. H02G 1/12

(52) U.S. Cl. CPC H02G 1/1253

(57) ABSTRACT

A bench top universal wire recycling system adapted to remove insulation from electrical wires in order to more efficiently recycle the wire is achieved by a lightweight bench top universal wire recycling system, a copper cut fixture is mounted in a housing which supports a wedge blank system. The wedge blank system includes a preset stop block with a modified spring plunger. A custom wedge blank permits large wires or very small wires to have insulation removed or stripped therefrom. The housing includes a blade block system, which allows for micro-adjustments in the wire stripping procedure. The blade in the blade block system has minimal or no contact with the metal of the wire, and efficient contact with the insulation to be removed from the wire.

This invention relates to a bench top universal wire recycling system and method and, more particularly, to a bench top universal wire recycling system and method, which may be used to treat scraps of an electrical conductor or wire and remove insulation from metal of the conductor and separate the conductor into insulation and metal. The bench top universal wire recycling system may be adjusted to handle different gages of wire.

### BACKGROUND OF THE INVENTION

Electric wiring is critical for the functioning of any building that requires electrical service. Installing this electrical wiring in order to provide the necessary electrical service for the building requires the services of a trained electrician to position the appropriate electrical conductor properly. The circuits formed by this electrical wiring provide electrical power for the building. Typically, the electrical wire has insulation secured around the elongated metal to conduct electricity as desired. During the course of the wiring project, an electrician will have wire scraps leftover from any electric wiring job. Such wire scraps are waste, which should be recycled. The job may be residential or commercial.

With the increase in the cost of copper wire or other electrical wiring, it becomes critical to efficiently recycle whatever wire scraps there may be. Typical wiring or electrical wire has an insulation coating around elongated metal. Providing metal for the wire to the recycler without insulation thereon approximately doubles the amount of money an electrician receives from the recycler for the insulated wire.

Effective insulation on a wire requires that the insulation be durable and firmly encapsulate the wire. Thus, removing the insulation from the wire is difficult. With the great increase in recycling prices of uninsulated wire, as opposed to insulated wire, it becomes clear that an efficient device for and method of removing insulation from wire for recycling offers great advantages to the electrician trying to efficiently recycle his scrap wire.

Electrical wires come in many different diameters. It can be difficult for wire strippers to efficiently remove insulation from wire scrap. If a bench top universal wire recycling system can be easily adjusted to handle many different sizes of wire, removing insulation from a wire can be accomplished more efficiently.

It is desirable to minimize damage to the metal of the wire itself as the insulation is removed therefrom. Damage to the wire can occur as the insulation is cut in order to facilitate removal of the insulation from the wire. With less damage to the wire, removal of the cut insulation is greatly simplified, and the metal thus freed can be recycled.

### SUMMARY OF THE INVENTION

Among the many objectives of this invention is the provision of a bench top universal wire recycling system, which may be used to remove insulation from a wire to free up the metal as desired.

A further objective of this invention is the provision of a bench top universal wire recycling system that can easily be adjusted to accommodate various sizes of wire.

A still further objective of this invention is the provision of a bench top universal wire recycling system that minimizes damage to the wire as the insulation is removed therefrom.

These and other objectives of the invention (which other objectives become clear by consideration of the specification, claims and drawings as a whole) are met by providing a bench top universal wire recycling system adapted to remove insulation from electrical wires in order to more efficiently recycle the wire. A lightweight bench top universal wire recycling system, a copper cut fixture is mounted in a housing which supports a wedge blank system. The wedge blank system includes a preset stop block with a modified spring plunger. A custom wedge blank permits large wires or very small wires to have insulation removed or stripped therefrom. The housing includes a blade block system, which allows for micro-adjustments in the wire stripping procedure. The blade in the blade block system has minimal or no contact with the metal of the wire, and efficient contact with the insulation to be removed from the wire.

### BRIEF DESCRIPTION OF THE DRAWINGS

FIG. 1 depicts a top, front perspective view of a bench top universal wire recycling system of this invention as an assembled wire stripper 102.

FIG. 2 depicts a top, rear perspective view of a bench top universal wire recycling system 100 of this invention as an assembled wire stripper 102, based on FIG. 1.

FIG. 3 depicts a bottom, perspective view of a bench top universal wire recycling system of this invention as an assembled wire stripper based on FIG. 2.

FIG. 4 depicts a top, front perspective view of a bench top universal wire recycling system 100 of this invention acting on a wire 106.

FIG. 5 depicts a plan cross-section view of a left blade block 140 for bench top universal wire recycling system of this invention as an assembled wire stripper 102 based on Line 5-5 of FIG. 4.

FIG. 6 of at depicts a top perspective view of a bench top universal wire recycling system of this invention as an exploded wire stripper 104.

FIG. 7 depicts a side view of assembled wire stripper 102 for a bench top universal wire recycling system of this invention.

FIG. 8 depicts a perspective view of this invention for a bench top universal wire recycling system 100 as an assembled wire stripper 102 in combination with a peel cone mount 205.

FIG. 9 depicts a plan view of wedge blank 162 for a bench top universal wire recycling system of this invention.

FIG. 10 depicts an electrical wire recycling device 300 of this invention of which the bench top universal wire recycling system of FIG. 1 is a version. Throughout the figures of the drawings, where the same part appears in more than one figure of the drawings, the same number is applied thereto.

### DESCRIPTION OF THE PREFERRED EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, may be used with respect to the drawings. These and similar to directional terms are not to be construed to limit the scope of the invention in any manner. The words attach, connect, couple, and similar terms with their inflectional morphemes do not necessarily denote direct or intermediate connections, but may also include connections through mediate elements or devices.

To create a lightweight bench top universal wire recycling system, a copper cut fixture for removing insulation is mounted in a housing which supports a wedge blank system. The wedge blank system includes a preset stop block with a modified spring plunger. A custom wedge blank permits large wires or very small wires to have insulation removed or stripped therefrom. The housing includes a blade block system, which allows for micro-adjustments in the wire stripping procedure. The blade in the blade block system has minimal or no contact with the metal of the wire, and efficient contact with the insulation to be removed from the wire to recover and recycle the metal.

When the blade is set to the correct depth, the blade will have very minimal contact with the metal of the wire. A length of wire as short as nine centimeters can be pushed or pulled through the lightweight bench top universal wire recycling system; with pliers, if necessary; to provide a slit in the insulation. The slit permits the insulation to be removed from the wire, so that the metal can be isolated for recycling. A longer piece of wire can be pulled through the lightweight bench top universal wire recycling system with one hand while the other hand removes the plastic or other insulation from wire. Readjustment of the blade may be necessary to facilitate maneuvering of the wire through the lightweight bench top universal wire recycling system.

The bench top universal wire recycling system is precision designed to remove insulation from stranded wire or solid wire by use of the web system with a preset stop block using a modified spring plunger. It can cover wire sizes many types. The wires can be number one gage to 500 MCM cable. Custom wedge blanks can be made for any size of wire up to 500 MCM cable.

When the blade is set to the correct depth, the blade should not touch the copper. However, the blade may contact the copper in some spots. This bench top universal wire recycling system can strip a piece of wire as short as three inches long. The wire is just pushed through the back of the bench top universal wire recycling system. At the wire comes out, it is possible to grab the end wire and pull wire through with pliers, or other appropriate tool. In this way, the installation can be peeled away. With the insulation removed. Recycling value of the wire is about double that of the insulated wire.

With a long piece of wire, it is possible to pull the wire through with one hand and remove insulation with the other. If the blade is set too high, minor adjustment has to be made to get the wire through the bench top universal wire recycling system.

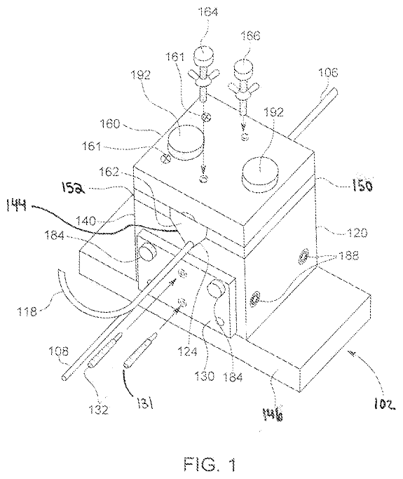

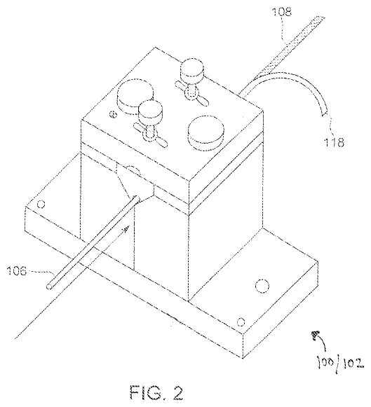

Now considering FIG. 1 and FIG. 2, lightweight bench top universal wire recycling system 100 is shown as assembled wire stripper 102. The right blade block 120 is secured adjacent to left blade block 140, with blade 114 held therebetween, by mounting base 146. Top plate 160 further secures right blade block 120 to left blade block 140. Wire 106 is passed over blade 114 to permit metal 108 to be separated from wire coating 118. Right riser 150 is positioned between right blade block 120 and top plate 160, while left riser 152 is positioned between left blade block 140 and top plate 160.

Right thumbscrew 164 holds top plate 160 on right blade block 120 while left thumb screw 166 holds top plate 160 on left blade block 140. Right thumbscrew 164 and left thumb screw 166 are hand operated to facilitate changes, but other holding devices are operable. Top plate pins 161 assist to hold plate 160 in a proper position,

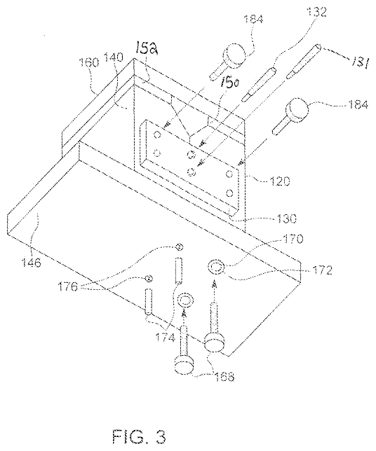

In FIG. 3, mounting base 146 holds right blade block 120 adjacent to left blade block 140 with frame screws 168. A frame screw 168 fits into a threaded relationship with each frame aperture 170. Each frame aperture 170 has a frame bevel 172, so that frame screw 168 will maintain a flat surface for mounting base 146. Frame pins 174 fit into frame apertures 176 to further stabilize the relationship between mounting base 146, right blade block 120 and left blade block 140.

Also, in FIG. 3, blade adjusting block 130 is held in position by adjusting screw 178. With adjusting screw 178, blade adjusting block 130 has wire support apertures 180, which receives the wire 106 for processing, as shown in FIG. 2.

A modified vlier spring plunger 132 is slidably mounted in blade adjusting block 130 to also facilitate the positioning of the blade. Spring plunger pin 115 is slidably mounted in left blade block 140 to adjust the position of blade 114 in order to contact wire coating 118. Riser 117 permits msm 500 cable to have a coating removed.

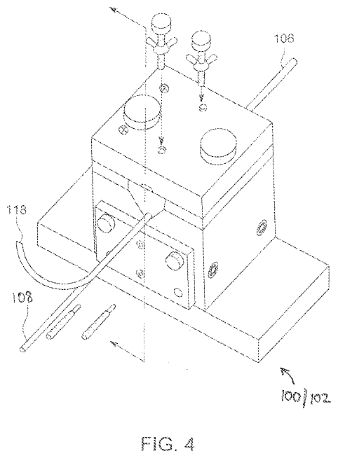

Further considering FIG. 4, assembled wire stripper 102 has wire 106 passing over blade 114 mounted in wedge blank 162. Right blade block 120 and left blade block 140 cooperate to support wedge blank 162. Right riser 150 and left riser 152 are positioned on a top portion of right blade block 120 and left blade block 140 and further support wedge blank 162. Top plate 160 covers wedge blank 162, right riser 150 and left riser 152.

As wire 106 passes between wedge blank 162 and blade 114, metal 108 and wire coating 118 are separated. Cable riser 117 assists with the stripping process. Right thumb screw 164 and left thumb screw 166 hold top plate 160 in position. Blade adjusting block 130 assists in guiding the wire 106 through the assembled wire stripper 102.

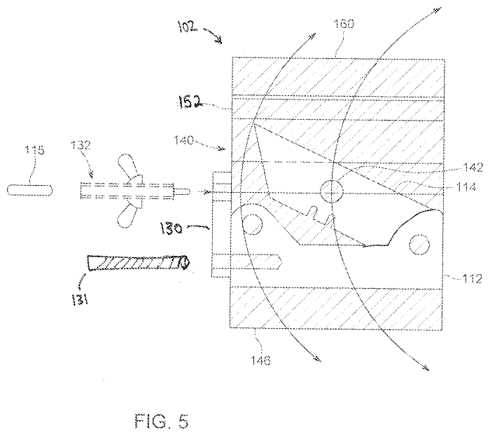

Additionally, FIG. 5 shows blade assembly 200 with the bottom blade spacer 112 to support blade 114 on left blade block 140. Spacer apertures 190 receive left block knobs 192 and permit bottom blade spacer 112 to hold blade 114 in a desired position for removing coating 118 from metal 108.

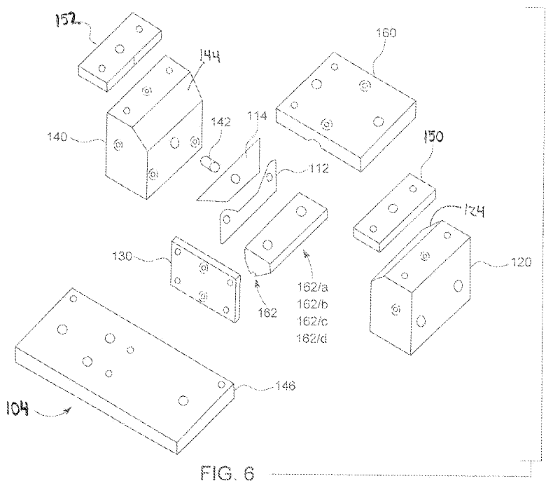

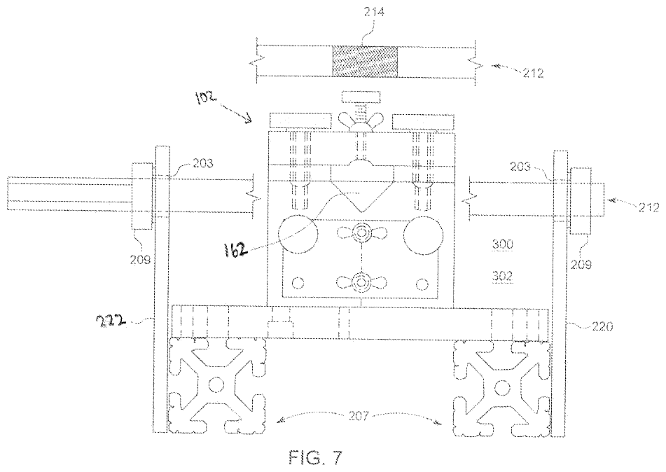

Now referring to FIG. 6 and FIG. 7, bench top universal wire recycling system 100 is shown as an exploded wire stripper 104. A right blade block 120 for bench top universal wire recycling system 100 cooperates with left blade block 140 for bench top universal wire recycling system 100. Top plate 160 for bench top universal wire recycling system 100 joins right blade block 120 to left blade block 140 to support blade assembly 200 (FIG. 5) therebetween, in order to provide a wire stripping function.

Right blade block 120 for bench top universal wire recycling system 100 is joined to left blade block 140. Right blade block 120 and left blade block 140 are substantially similar in shape, but differ in the number of apertures therein. Right blade block 120 has the right blade support 122 capable of working with pivot pin blade 142 on left blade block 140 to support blade assembly 200 therebetween.

Blade adjusting block 130 connects right blade block 120 to left blade block 140 and supports blade assembly 200 between right blade block 120 and left blade block 140. Right blade block 120 and left blade block 140 are rectangular solids with apertures therein and an edge removed therefrom.

Right blade block 120 has a right flat support 124, while left blade block 140 has a left flat support 144. Right flat support 124 cooperates with left flat support 144 to provide a mounting base 146 for the wedge blank 162 and the blade assembly 200. Right flat support 124 and left flat support 144 are each formed by removing a triangular cross section of material from a corner of right blade block 120 and left blade block 140 respectively.

Wire handler is adjusted by wedge blank 162 and its variations—the 14/12 wedge blank gage 162a handles 14/12 gage wire, wedge blank gage 162b handles 10 gage wire, wedge blank gage 162c handles 6 or 8 wedge blank duties, and wedge blank gage 162d handles #3 gage wires.

Blade assembly 200 includes blade 114 supported by blade shim 182. Blade shim 182 assists with the holding of blade 114 in a desired position between left blade block 140 and right blade block 120 in order to permit wire 106 to be passed over blade 114 and have wire coating 118 cut so that metal 108 can be separated from the wire coating 118.

With the addition of FIG. 6 and FIG. 7 to the consideration, the exploded wire stripper 104 clarifies the function of bench top universal wire recycling system 100. The right blade block 120 is secured adjacent to left blade block 140, with blade 114 held therebetween, by mounting base 146. Top plate 160 further secures right blade block 120 to left blade block 140.

Mounting base 146 can hold right blade block 120 adjacent to left blade block 140 with frame screws 168. A frame screw 168 fits into a threaded relationship with each frame aperture 170. Each frame aperture 170 has a frame bevel 172, so that frame screw 168 will maintain a flat surface for mounting base 146. Frame pins 174 fit into frame apertures 176 to further stabilize the relationship between mounting base 146, right blade block 120 and left blade block 140.

As wire 106 passes between wedge blank 162 and blade 114, metal 108 and wire coating 118 are separated. Right thumb screw 164 and left thumb screw 166 hold top plate 160 in position. Blade assembly 200 cooperates with the bottom blade spacer 112 to support blade 114 on left blade block 140. Spacer apertures 190 receive left block knobs 192 and permit bottom blade spacer 112 to hold blade 114 in a desired position for removing coating 118 from metal 108.

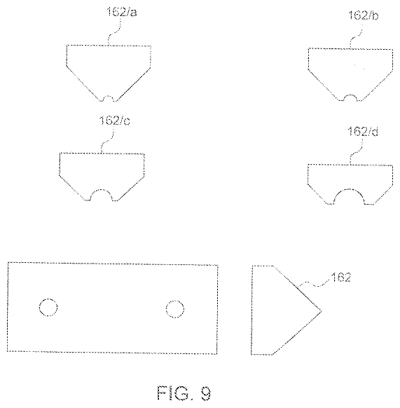

Assembled wire stripper 102 comes with any desired number of wedges. Four wedges, which are particularly useful, include those made for #3, #6, #8, #10, #12, and #14 wire as shown in FIG. 9. The V and wedge system are the most useful part of assembled wire stripper 102. Custom wedges can be made to handle any range of wire sizes, as can be seen from wedge blank 162 and its derivatives wedge 162a, wedge 162b, wedge 162c and wedge 162d. Reference to standard wire gage sizes can lead to other adjustments, especially when FIG. 9 is considered.

Still considering FIG. 6 and FIG. 7, bench top universal wire recycling system 100 is shown as an exploded wire stripper 104 (FIG. 6). A right blade block 120 for bench top universal wire recycling system 100 cooperates with left blade block 140 for bench top universal wire recycling system 100. Top plate 160 for bench top universal wire recycling system 100 joins right blade block 120 to left blade block 140 to support blade assembly 200 (FIG. 5) therebetween, in order to provide a wire stripping function.

Right blade block 120 for bench top universal wire recycling system 100 is joined to left blade block 140. While right blade block 120 and left blade block 140 are substantially similar in shape, they differ in the number of apertures therein. Right blade block 120 has the right blade support 122 capable of working with the pivot pin blade 142 on left blade block 140 to support blade assembly 200 therebetween. Blade adjusting block 130 connects right blade block 120 to left blade block 140 and supports blade assembly 200 between right blade block 120 and left blade block 140. Right blade block 120 and left blade block 140 are rectangular solids with apertures therein and an edge removed therefrom.

Right blade block 120 has a right flat support 124, while left blade block 140 has a left flat support 144. Right flat support 124 cooperates with left flat support 144 to provide a mounting base 146 for the wedge blank 162 and the blade assembly 200. Right flat support 124 and left flat support 144 are each formed by removing a triangular cross section of material from a corner of right blade block 120 and left blade block 140 respectively.

Blade assembly 200 includes blade 114 supported by blade shim 182. The blade shim 182 further assists with the holding of blade 114 in a desired position between left blade block 140 and right blade block 120. A modified vlier spring plunger 132 is slidably mounted in adjusting block 130 to facilitate positioning of the blade 114. Right to left block screws 188 further support the blade assembly 200 between the right blade block 120 and the left blade block 140.

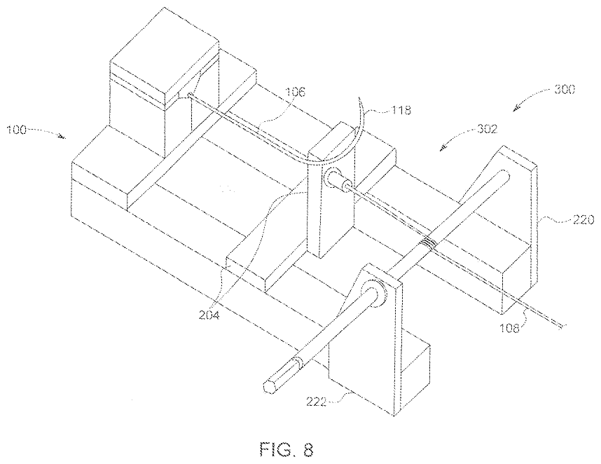

As FIG. 8 is added to the discussion, bench top universal wire recycling system 100 is mounted on a wire drawing device 210. Mounting base 146 of assembled wire stripper 102 is secured to the fixed end 212 of wire drawing device 210. Wire 106 runs from assembled wire stripper 102 through a peel off cone 202 mounted in a peel cone mount 205, which separates the wire coating 118 from the metal 108. Typically, the metal 108 is copper and the wire coating 118 is plastic. Bushing 203 is preferably iolite with a 0.5 inch inside diameter.

Extrusion base 207 receives wire 106 by virtue of the large wire pushrod head 206 and large wire push rod handle 208 and directs it to the peel cone mount 205. Clamp collar 209 supports the peel cone mount 205.

From the peel off cone 202, wire 118 is wrapped around a wired shaft 212. If desired, a coarse knurl 214 can assist to recover the metal 108. The shaft 212 is rotatably mounted in two oppositely disposed shaft mounts. There is a first shaft mount 220 and a second shaft mount 222 supporting wired shaft 212. A drill or other suitable device (not shown) can be used to turn the wired shaft 212 and pull the metal 118 through the peel cone 202.

Clamp 209 assists with this mounting and is preferably a 0.5 inch clamp.

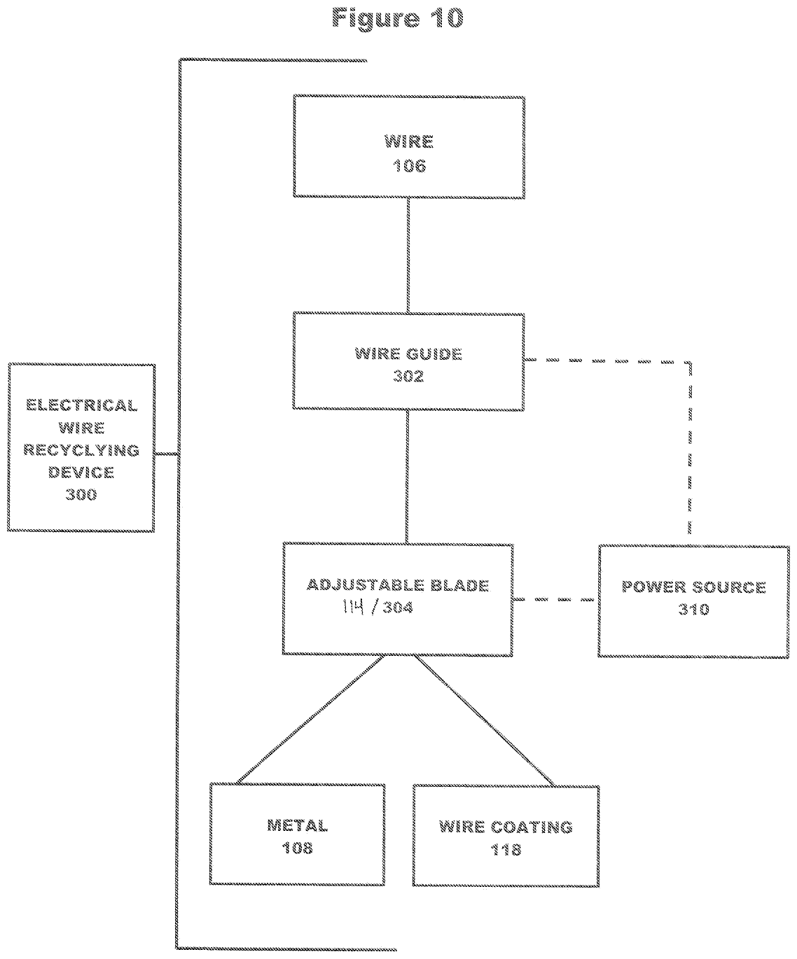

In FIG. 10, electrical wire recycling device 300 is depicted. The bench top universal wire recycling system 100 is a version of the electrical wire recycling device 300. Electrical wire recycling device 300 receives wire 106 from wire guide 302. Wire guide 302 passes wire 106 over adjustable blade 304 and removes wire coating 118 from metal 108. With the wire guide 302 positioning of the wire 106 relative to the adjustable blade 304, coating 118 is cut permitting wire coating 118 to be removed from metal 108. Typically, wire coating 118 is a thermoplastic, and metal 108 is copper.

Electrical wire recycling device 300 permits easy separation of wire coating 118 from metal 108. If a power source 310 pulls the wire 106 from the wire guide 302 over adjustable blade 304 even greater advantages are obtained. Recycling services pay roughly double for uncoated wire as is paid for coated wire. Having such a simple, portable and effective wire stripper provides a great advantage for recyclers and electricians alike.

This application; taken as a whole with the abstract, specification, claims, and drawings being combined; provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed and sought to be protected by Letters Patent of the United States is:

1. A bench top universal wire recycling system comprising:
an assembled wire stripper includes a blade, a left blade block, and a right blade block, a mounting base, a top plate, a wedge blank, and a blade adjusting block;
the mounting base adjacently connects the left blade block to the right blade block;
the mounting base has a plurality of left blade block mounting apertures and a plurality of right blade block mounting apertures;
the left blade block and the right blade block support the blade; the blade assists with a separation of a wire into metal and insulation; and
a plurality of blade assembly mounting apertures provide for an adjustment in the blade based on a size of the wire.

2. The bench top universal wire recycling system of claim 1 further comprising:
a plurality of mounting base apertures secure the mounting base to a surface;
the left blade block has a plurality of base left blade block apertures to secure the left blade block to the left blade block mounting apertures;
the right blade block has a plurality of base right blade block apertures to secure the right blade block to the right blade block mounting apertures;
the blade assembly has a plurality of base blade apertures to secure the blade assembly to the blade assembly mounting apertures;
the top plate has a plurality of left blade block top plate apertures, a plurality of right blade block top plate apertures, and a plurality of wedge blank top plate apertures; and
the left blade block has a plurality of top plate left blade block apertures to secure the left blade block to the left blade block top plate apertures.

3. The bench top universal wire recycling system of claim 2 further comprising:
the right blade block has a plurality of top plate right blade block apertures to secure the right blade block to the right blade block top plate apertures;
the wedge blank has a plurality of top plate wedge blank apertures to secure the wedge blank to the wedge blank top plate apertures;
the right blade block and left blade block are secured to the mounting base;
the left blade block has a left blade block interior side, a left blade block exterior side, a left blade block back side and a left blade block front side; the left blade block interior side is angled to receive the wedge blank; the left blade block exterior side is a flat surface;
the left blade block front side has a plurality of blade adjusting block left blade block apertures; and
the right blade block has a right blade block interior side, a right blade block exterior side, a right blade block front side, and a right blade block back side.

4. The bench top universal wire recycling system of claim 1 further comprising:
the right blade block interior side is shaped to fit the wedge blank; the right blade block exterior side is a flat surface;
the right blade block front side has a plurality of right blade block apertures;
the wedge blank has a wedge blank bottom triangular side and a wedge blank top flat side;
the wedge blank bottom triangular side has an angle allowing the right blade block interior side and the left blade block interior side to support the blade assembly; and
the wedge blank bottom triangular side has a wedge blank wire gage aperture to secure a wire therein.

5. The bench top universal wire recycling system of claim 4 further comprising:
the blade assembly has a bottom blade spacer, a blade, and a blade adjusting block;
the bottom blade spacer has a plurality of bottom blade spacer apertures that cooperate with the plurality of right blade block apertures and the plurality of left blade block apertures to suspend the blade assembly between the right blade block and the left blade block; and
the blade has a blade aperture to cooperate with the right blade block and the left blade block to further support the blade assembly between the right blade block and the left blade block.

6. In a wire stripper for a bench top universal wire recycling system, the improvement comprising:
an assembled wire stripper includes a blade assembly, a left blade block, a right blade block, a mounting base, a top plate, a wedge blank, and a blade adjusting block;
a copper cut fixture is mounted in a housing which supports a wedge blank system;
the wedge blank system includes a preset stop block with a modified spring plunger to provide contact with an insulation on a wire to be stripped of the insulation in order to recover a metal of the wire;
the custom wedge blank system permits large wires or very small wires to have insulation removed or stripped therefrom;
the housing includes a blade block system, which allows for micro-adjustments in the wire stripping procedure;
a blade in the blade block system has minimal or no contact with the metal of the wire, and efficient contact with the insulation to be removed from the wire; and
the blade is set to a depth to remove the insulation from the metal.

7. The wire stripper of claim 6 further comprising:
an assembled wire stripper includes the blade assembly supporting a blade;
the blade has minimal or no contact with the metal of the wire;
the blade cuts insulation from a stranded wire or a solid wire by use of a web system;
the web system includes a preset stop block using a modified spring plunger to cover wire sizes of many types;
the right blade block is secured adjacent to the left blade block with the blade assembly mounted therebetween;
a mounting base secures the right blade block adjacent to the left blade block; and
a mounting base supports the blade between the right blade block and the left blade block.

8. The wire stripper of claim 7 further comprising:
a right riser is positioned between the right blade block and the top plate:
a left riser is positioned between the left blade block and the top plate;
a right thumbscrew holds the top plate on the right blade block; a left thumb screw holds the top plate on the left blade block:
at least one frame screw holds the mounting base to the right blade block; and
at least one frame screw holds the mounting base to the left blade block.

9. The wire stripper of claim 8 further comprising: a frame aperture receives the at least one frame screw;
the frame aperture has a frame bevel to provide a relatively flat surface for the at least one frame screw with the mounting base;
the at least on frame screw holds the right blade block adjacent to the left blade block;
the mounting base includes at least one pin aperture; and
the at least one pin aperture receives a frame to further stabilize a relationship between the mounting base, the right blade block and left blade block.

10. The wire stripper of claim 9 further comprising: the blade assembly includes a blade adjusting screw;
the blade adjusting block has wire support apertures, which receives a wire of a desired size for processing;
a right riser is positioned on a top portion of right blade block and covered by the top plate;
a left riser is positioned on a top portion of left blade block and covered by the top plate;
the top plate covers the wedge blank, the right riser and the left riser;
the blade assembly includes a bottom blade spacer to support the blade on the left blade block;
the bottom blade spacer includes at least one spacer aperture; and
the at least one spacer aperture receives a left block knob on the left block to permit the bottom blade spacer to hold the blade in a desired position for removing the coating from the metal.

11. The wire stripper of claim 10 further comprising:
the right blade block is substantially similar in shape to the left blade block, but differ in the number of apertures therein;
the right blade block has the right blade support capable of working with the left blade support on the left blade block to support the blade assembly therebetween.
The right blade block has a right flat support;
the left blade block has a left flat support;
the right flat support cooperates with the left flat support to support the wedge blank and the blade assembly;
the blade assembly includes the blade supported by a blade shim; and the blade shim supports the blade in a desired position between the left blade block and the right blade block.

12. The wire stripper of claim 1 further comprising:
the top plate joins the right blade block to the left blade block in order to support the blade assembly therebetween and provide a wire stripping function.
the blade adjusting block connects the right blade block to the left blade block and supports the blade assembly therebetween;
the right blade block and the left blade block are rectangular solids with apertures therein and an edge removed therefrom;
the right blade block has a right flat support caused by removal of the edge;
the left blade block has a left flat support caused by removal of the edge;
the right flat support cooperates with the left flat support to provide a mounting base for the wedge blank and the blade assembly; and
the blade assembly includes the blade supported by the blade shim.

13. The wire stripper of claim 12 further comprising the wire stripper is mounted on a wire drawing device;
the mounting base of the wire stripper is secured to a fixed end of a wire drawing device;
the wire drawing device having a peel cone mount adjacent to the fixed end to receive wire being stripped of the insulation;
the wire runs form the peel cone mount to a wired shaft;
the wired shaft rotates to pull or collect the wire without the coating; and the wired shaft is rotatably mounted in a first shaft mount oppositely disposed from a second shaft mount.

14. The wire stripper of claim 13 further comprising
the right blade block and the left blade block cooperate to support the wedge blank;
the right riser and the left riser are positioned on a top portion of the right blade block and the left blade block to further support wedge blank; a top plate covers the wedge blank, the right riser and the left riser; the wire passes between the wedge blank and the blade to separate the metal and the wire coating;
a right thumb screw holds the right riser under the top plate; and
a left thumb screw holds the left riser under the top plate.

15. The wire stripper of claim 14 further comprising:
the blade adjusting block in guides the wire through the assembled wire stripper;
the blade assembly cooperates with the bottom blade spacer to support blade on the left blade block;
spacer apertures receive the left block knobs and hold bottom blade spacer in a desired position for removing coating from metal; and
the wire runs from the wire stripper through a peel off cone mounted in a peel cone mount, which separates the wire coating from the metal.

16. The wire stripper of claim 15 further comprising:
a power drill is used to turn the wired shaft and pull the metal through the peel cone;

17. A method of separating wire into metal and coating components comprising:
providing wire to an electrical wire recycling device;
using the electrical wire recycling device to separate the wire into coating and metal;
running the electrical wire across an adjustable blade;
cutting the coating with minimal or no contact with the metal; removing the coating recovering the metal; and
recycling the metal.

18. The method of claim 17 further comprising: the wire coating is a thermoplastic;
positioning the blade with the right blade block and the left blade block; passing the wire passing over the blade to cut the thermoplastic along a length of the wire; and
removing the thermoplastic from the wire to recover the metal;

19. The method of claim 18 further comprising:
providing wire to an electrical wire recycling device through a wire guide to compensate for a gage of the wire;
passing the wire from the wire guide to the adjustable blade;
recovering the coating;
recycling the coating.
cutting the coating; and
removing the coating to recover the metal.

20. The method of claim 19 further comprising: the wire coating is a thermoplastic;
the metal is copper;
pulling the wire from the wire guide over the adjustable blade;
using a power source to pull the wire; and
recovering the metal.
